(19) United States
(12) Patent Application Publication
(10) Pub. No.: US 2025/0077861 A1
(43) Pub. Date: Mar. 6, 2025

(54) APPARATUS, METHOD, DEVICE AND MEDIUM FOR LABEL-BALANCED CALIBRATION IN POST-TRAINING QUANTIZATION OF DNN

(71) Applicant: Intel Corporation, Santa Clara, CA (US)

(72) Inventors: Haihao SHEN, Shanghai (CN); Feng TIAN, Shanghai (CN); Xi CHEN, Shanghai (CN); Huma ABIDI, Danville, CA (US); Yuwen ZHOU, Shanghai (CN)

(73) Assignee: Intel Corporation, Santa Clara, CA (US)

(21) Appl. No.: 18/574,995

(22) PCT Filed: Nov. 3, 2021
(86) PCT No.: PCT/CN2021/128507

§ 371 Date: Dec. 28, 2023

(51) Int. Cl. G06N 3/08; G06N 3/0495; G06V 10/774

(52) U.S. Cl. CPC G06N 3/08; G06N 3/0495; G06V 10/774

(57) ABSTRACT

The disclosure provides an apparatus, method, device and medium for label-balanced calibration in post-training quantization of DNNs. An apparatus includes interface circuitry configured to receive a training dataset and processor circuitry coupled to the interface circuitry. The processor circuitry is configured to generate a small ground truth dataset by selecting images with a ground truth number of 1 from the training dataset; generate a calibration dataset randomly from the training dataset; if any image in the calibration dataset has the ground truth number of 1, remove the image from the small ground truth dataset; generate a label balanced calibration dataset by replacing an image with a ground truth number greater than a preset threshold in the calibration dataset with a replacing image selected randomly from the small ground truth dataset; and perform calibration using the label balanced calibration dataset in post-training quantization. Other embodiments are disclosed and claimed.

### TECHNICAL FIELD

Embodiments of the present disclosure generally relate to techniques of deep neural networks (DNNs), and in particular to an apparatus, method, device, and medium for label-balanced calibration in post-training quantization of DNNs.

### BACKGROUND ART

Deep neural networks (DNNs) have been improved rapidly in recent years and show the state-of-the-art (SOTA) accuracy for a wide range of computation vision (CV) tasks. For example, image classification models (where each image includes a single label) have achieved 0.80 top-1 accuracy based on the ImageNet dataset including 1000 classes. However, for object detection models, where each image may include multiple labels, mean average precision (mAP) is still low based on the popular Microsoft (Ms) Common Objects in Context (COCO) dataset including 80 classes, for example, 0.29 mAP for a Mask region based convolutional neural network (R-CNN). Besides object recognition on an image (which is similar as image classification), object detection requires an additional metric to evaluate whether an overlapped area of a recognized object and corresponding ground truth object meets a threshold. In most cases of object detection, multiple objects on a single image may be overlapped.

### SUMMARY

According to an aspect of the disclosure, an apparatus is provided. The apparatus includes interface circuitry configured to receive a training dataset and processor circuitry coupled to the interface circuitry. The processor circuitry is configured to generate a small ground truth dataset by selecting images with a ground truth number of 1 from the training dataset; generate a calibration dataset randomly from the training dataset; if any image in the calibration dataset has the ground truth number of 1, remove the image from the small ground truth dataset; generate a label balanced calibration dataset by replacing an image with a ground truth number greater than a preset threshold in the calibration dataset with a replacing image selected randomly from the small ground truth dataset; and perform calibration using the label balanced calibration dataset in post-training quantization of a deep neural network (DNN).

According to another aspect of the disclosure, a method is provided. The method includes generating a small ground truth dataset by selecting images with a ground truth number of 1 from a training dataset; generating a calibration dataset randomly from the training dataset; if any image in the calibration dataset has the ground truth number of 1, removing the image from the small ground truth dataset; generating a label balanced calibration dataset by replacing an image with a ground truth number greater than a preset threshold in the calibration dataset with a replacing image selected randomly from the small ground truth dataset; and performing calibration using the label balanced calibration dataset in post-training quantization of a deep neural network (DNN).

Another aspect of the disclosure provides a device including means for implementing the method of the disclosure.

Another aspect of the disclosure provides a machine readable storage medium having instructions stored thereon, which when executed by a machine cause the machine to perform the method of the disclosure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a flow chart of an exemplary method of label balanced calibration in post-training quantization of a DNN accordance with some embodiments of the disclosure.

FIG. 2 shows example samples with multiple ground truth labels from the COCO dataset.

FIG. 3 shows ground truth label distribution of the COCO2014 dataset and COCO 2017 dataset.

FIG. 4 shows a flow chart of an exemplary process to generate a label balanced calibration dataset in accordance with some embodiments of the disclosure.

FIG. 5 shows an improvement of low precision statistics accuracy after using a label balance technique for the You Only Look Once, Version 3 (YOLOv3) model.

FIG. 6 shows an improvement of low precision statistics accuracy after using the label balance technique for the Mask R-CNN model.

FIG. 7 is a block diagram illustrating components, according to some example embodiments, able to read instructions from a machine-readable or computer-readable medium and perform any one or more of the methodologies discussed herein.

FIG. 8 is a block diagram of an example processor platform in accordance with some embodiments of the disclosure.

### DETAILED DESCRIPTION OF EMBODIMENTS

Various aspects of the illustrative embodiments will be described using terms commonly employed by those skilled in the art to convey the substance of the disclosure to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrases “in an embodiment” “in one embodiment” and “in some embodiments” are used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

With the improvement of hardware, more and more DNN models are being deployed in real-life applications, e.g., vehicle plate recognition, pedestrian detection, and security surveillance, etc. Low precision is one of promising techniques to speed up inference performance of the DNN models by leveraging hardware acceleration support such as the Intel DL Boost VNNI. However, it is not easy for industry deployment of low precision solution due to the strict accuracy requirement. It is a challenging problem to achieve the optimal performance while keeping statistics accuracy of the DNN models.

Post-training quantization is a process to reduce precision of parameters of DNN models (such as neural network weights) from the precision as trained (such as float 32 bits, e.g. FP32) to lower precision (such as integer 8 bits (i.e., INT8) or float 16 bits), in order to perform huge calculation work quickly with the lower precision.

Some recent works prove successful application of low precision inference in image classification using post-training quantization (training-free solution) and demonstrate acceptable INT8 accuracy within relative 1% loss of the statistics accuracy. However, it is still challenging to apply low precision inference to multi-label DNNs with relatively low SOTA accuracy loss.

The term “multi-label DNNs” used herein may include multi-label DNNs for object detection or instance segmentation.

Table 1 is shown as an example to illustrate differences between image classification and object detection (or instance segmentation).

TABLE 1

| | Image Classification | Object Detection |
|---|---|---|
| Labels on an Image | Single Label | Multiple Labels |
| Evaluation Metric | Top-K (Top-1/Top-5) | mean Average Precision |
| | | (mAP) |
| Dataset | ImageNet | COCO2014 / COCO2017 |
| Classes | 1000 | 80 |
| Training Samples | 1.28M | 117K |
| SOTA accuracy | 76%~88% | 28%~55% |

As shown in Table 1, image classification relates to images, each of which includes a single label, while object detection relates to images, which of which may include multiple labels. The accuracy of a DNN model for image classification may be evaluated by op-K (Top-1/Top-5), while the accuracy of a DNN model for object detection may be evaluated by mean Average Precision (mAP). The DNN model for image classification may be trained using, for example, the ImageNet dataset including 1000 classes, while the DNN model for object detection may be trained using, for example, the COCO2014 or COCO2017 dataset including 80 classes, is widely used as the standard benchmark dataset. A number of training samples for the DNN model for image classification may be 1.28 million, while a number of training samples for the DNN model for object detection may be 1,170. The SOTA accuracy of the DNN model for image classification may be 76%˜88%, while the SOTA accuracy of the DNN model for object detection may be 28%˜55%.

As a result, under the same accuracy criteria (for example, relative 1% loss), as compared with image classification, there are 1.4 times to 3.1 times more difficulties for object detection to achieve the accuracy goal. Some previous solutions have implemented low precision (e.g., INT8) accuracy on compute vision applications mainly for image classification using post-training quantization or training-aware quantization. However, there is no previous work showing acceptable low precision accuracy for object detection based on multi-label DNNs with low SOTA accuracy, e.g., object detection based on the COCO dataset.

Embodiments of the present application provide a novel calibration technique called label balance to be used in the post-training quantization of multi-label DNNs. The label balance calibration technique can avoid dynamic data range conflicts due to ground truth label overlap in calibration samples for multi-label DNNs. According to the present disclosure, label balance can be seamlessly integrated into a typical calibration flow, and therefore the online business process of the post-training quantization would not be changed.

The present disclosure provides solutions to keep low precision statistics accuracy for multi-labels DNNs with low SOTA accuracy by integrating the label balance technique into the conventional post-training quantization. The solutions can be promoted into all Intel® optimized deep learning frameworks and facilitate deploying low precision (e.g., INT8) inference on cloud service easily and rapidly.

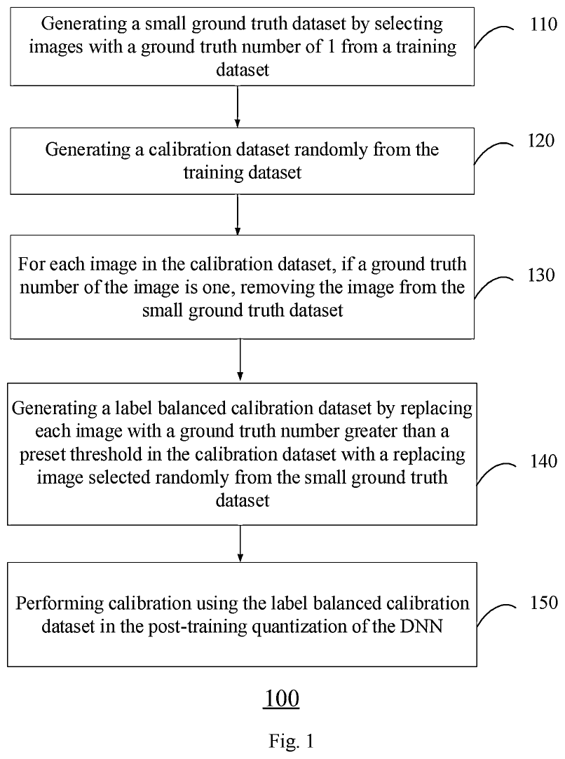

FIG. 1 shows a flow chart of an exemplary method 100 of label balanced calibration in post-training quantization of a DNN accordance with some embodiments of the disclosure.

As mentioned, the post-training quantization may be performed after the DNN has been trained, to reduce precision of parameters of the DNN from the precision as trained (such as float 32 bits) to lower precision (such as integer 8 bits (i.e., INT8) or float 16 bits).

The method 100 includes, in block 110, generating a small ground truth dataset (which may be named as “SmallGT”, for example) by selecting images with a ground truth number of 1 from a training dataset.

According to embodiments of the present disclosure, the term “ground truth number of an image” refers to the number of ground truth labels included in the image. For example, an image with a ground truth number of 1 means that the image has a single ground truth label.

In an embodiment, the method 100 may be performed using the well-known Ms COCO (e.g., COCO2014 or COCO2017) dataset or any other appropriate dataset as the training dataset, which is not limited herein.

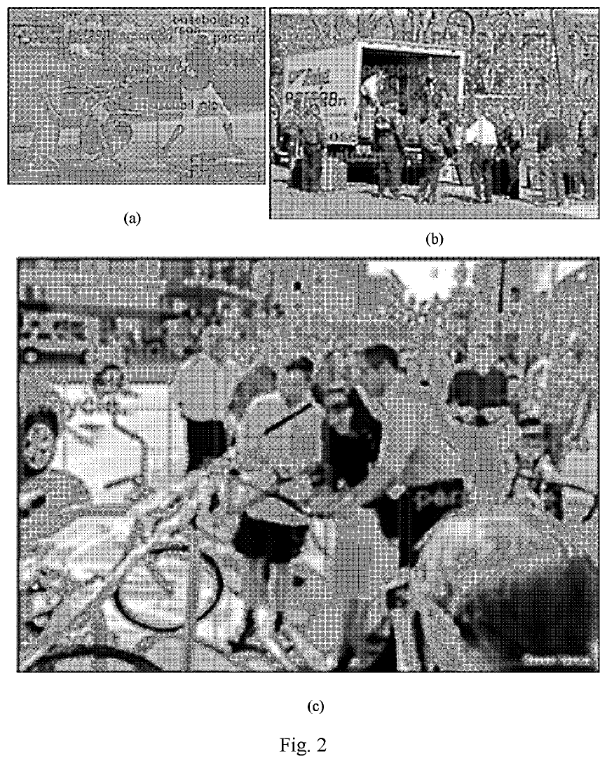

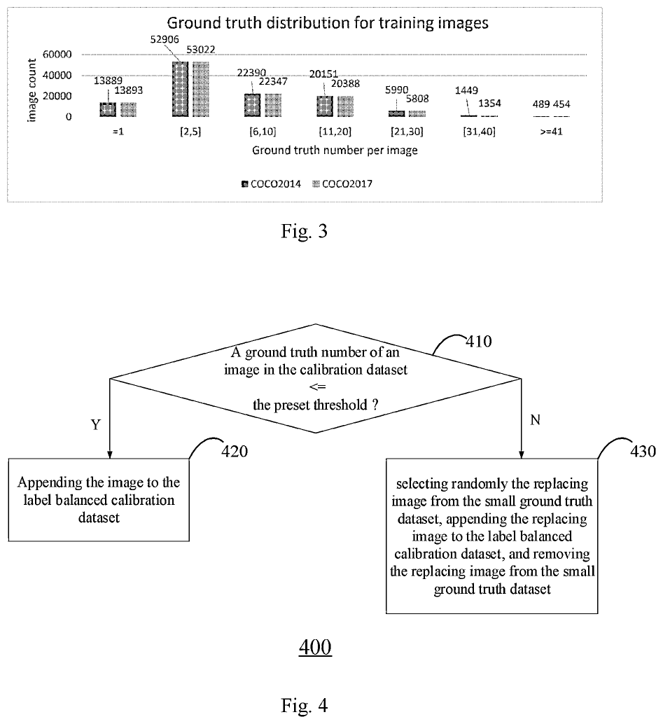

FIG. 2 shows example samples with multiple ground truth labels from the COCO dataset. It should be noted that the different areas of images (a)-(c) shown in FIG. 2 are only for clear display, which have no limitation on the actual sizes of the images. As shown, each image may include more than 10 labels, and the image (c) includes up to 25 labels. FIG. 3 shows ground truth label distribution of the COCO2014 dataset and COCO 2017 dataset. As shown, about 12% of samples have only 1 label and the remaining samples have more than 2 labels, in both the COCO2014 dataset and COCO2017 dataset.

The method 100 includes, in block 120, generating a calibration dataset (which may be named as “CAL”, for example) randomly from the training dataset. That is to say, the calibration dataset may be selected randomly from the training dataset, e.g., the COCO2014 dataset and COCO 2017 dataset. The calibration dataset may include images with 1 label and images with multiple labels.

According to blocks 110 and 120, the small ground truth dataset includes all images with the ground truth number of 1 from the training dataset, and the calibration dataset includes images selected randomly from the training dataset, which may include some images with the ground truth number of 1. In order to make sure that there is no intersection between the small ground truth dataset and the calibration dataset, for each image in the calibration dataset, if a ground truth number of the image is one, the image is removed from the small ground truth dataset, as illustrated in block 130 of FIG. 1.

After the small ground truth dataset and the calibration dataset are determined, the method 100 may include, in block 140, generating a label balanced calibration dataset (which may be named as “label_balance_CAL”, for example) by replacing each image with a ground truth number greater than a preset threshold in the calibration dataset with a replacing image selected randomly from the small ground truth dataset.

The threshold may be preset according to ground truth label distribution of the training dataset, for example, the ground truth label distribution of the COCO2014 dataset and COCO 2017 dataset as shown in FIG. 3. As an example, the preset threshold may be 5 or any other appropriate number.

The method 100 may further include, in block 150, performing calibration using the label balanced calibration dataset in the post-training quantization of the DNN.

In general, the post-training quantization will select random samples from the calibration dataset (which is generated randomly from the training dataset) and collect dynamic data ranges (calibration statistics) for each quantizable operators (e.g., Convolution or MatMul) in the DNN model during the calibration stage. Therefore, for the conventional post-training quantization process, it is very likely to select random samples with multiple ground truth labels, when the COCO dataset is used for calibration, and dynamic data range conflict is more likely to happen due to more ground truth label overlap.

The method 100 of label balanced calibration can be seamlessly integrated into the typical calibration flow and can be transparent for end users to utilize this technique. According to the method 100 of the embodiments of the disclosure, the post-training quantization will select random samples from the label balanced calibration dataset that includes samples with balanced ground truth labels (i.e., not too many labels or not too great ground truth number), and therefore the dynamic data range conflict can be avoided effectively.

FIG. 4 shows a flow chart of an exemplary process 400 to generate the label balanced calibration dataset in accordance with some embodiments of the disclosure.

The exemplary process 400 may be performed to generate the label balanced calibration dataset as described in block 140 of FIG. 1, for example.

The process 400 may be performed for each image in the calibration dataset generated in block 120 of FIG. 1.

The process 400 may include, in block 410, determining whether a ground truth number of an image in the calibration dataset is not greater than the preset threshold.

If the ground truth number of the image is not greater than the preset threshold, the process 400 may include, in block 420, appending the image to the label balanced calibration dataset.

If the ground truth number of the image is not greater than the preset threshold, the process 400 may include, in block 430, selecting randomly the replacing image from the small ground truth dataset, appending the replacing image to the label balanced calibration dataset, and removing the replacing image from the small ground truth dataset.

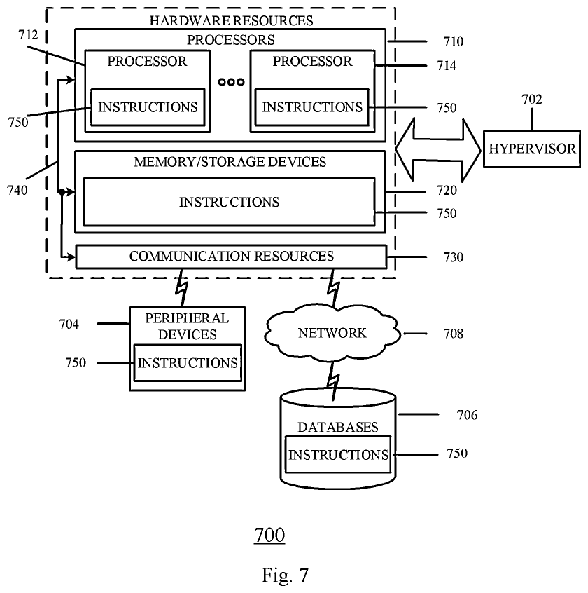

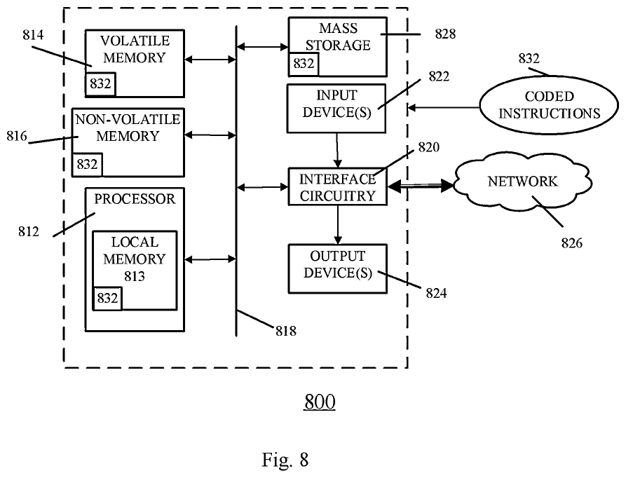

The methods or processes described in FIG. 1 and FIG. 4 may be implemented by hardware resources and/or processor platform which will detailed with reference to FIG. 7 and FIG. 8 below.

An example of pseudocode for implementing the label balance technique presented by embodiments of the disclosure is shown below.

```
SmallGT <− images with GroundTruth == 1 from training dataset
CAL <− random generate a calibration dataset from training
dataset
# To make sure SmallGT does not contain images with 1 GT that
already in CAL dataset
for IMAGE in CAL:
  if groundtruth number of IMAGE == 1:
    SmallGT.remove(IMAGE)
# To replace images containing large GT number with images
containing small GT number
label_balance_cal = [ ]
for IMAGE in CAL:
  if groundtruth number of IMAGE <= balanced_label_number:
    label_balance_cal.append(IMAGE)
  else:
    replace_img = random select 1 image from SmallGT
    SmallGT.remove(replace_img)
    label_balance_cal.append(replace_img)
```

The pseudocode may be stored in a machine-readable medium. The term “machine readable medium” may include any non-transitory medium that is capable of storing, encoding, or carrying instructions for execution by a machine and that cause the machine to perform any one or more of the techniques of the present disclosure, or that is capable of storing, encoding or carrying data structures used by or associated with such instructions.

Just as examples, in order to show advantages of the label balance technique provided by embodiments of the disclosure, the label balance technique has been applied to two object detection models: YOLOv3 on the Python based Torch (PyTorch), and Mask R-CNN on the TensorFlow. Table 2 shows the experimental configurations.

TABLE 2

| Model | Framework | Dataset | Metric | SOTA |
|---|---|---|---|---|
| YOLOv3 | PyTorch | COCO2014 | mAP@IoU = 0.50 | 51.45% |
| Mask | TensorFlow | COCO2017 | mAP@IoU = | 29.14% |
| R-CNN | | | 0.50:0.95 | |

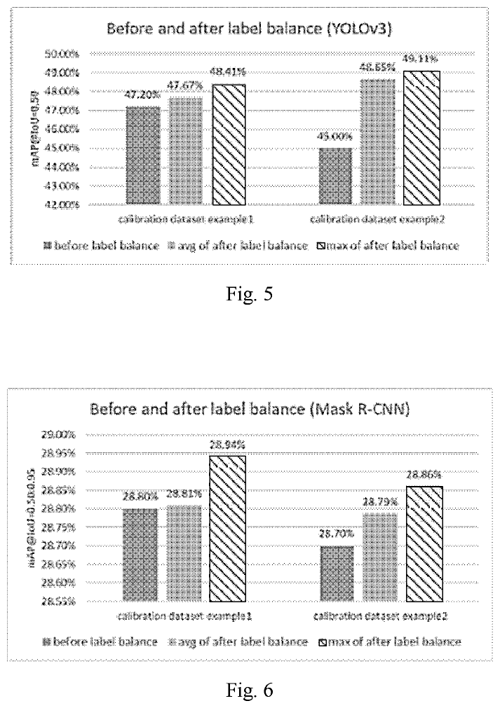

By using label balanced calibration in the post-training quantization of the two object detection models, the low precision statistics accuracy of each model has been improved significantly. FIG. 5 shows the improvement of low precision statistics accuracy after using the label balance technique for the YOLOv3 model. FIG. 6 shows the improvement of low precision statistics accuracy after using the label balance technique for the Mask R-CNN model.

As can be seen, using the label balance technique provided by embodiments of the disclosure, good INT8 accuracy has been achieved for each model, e.g., 49.11% for the Yolov3 model and 28.86% for the Mark R-CNN model. This is the first time to prove INT8 accuracy of multi-label DNNs under low SOTA accuracy using the post-training quantization.

FIG. 7 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 7 shows a diagrammatic representation of hardware resources 700 including one or more processors (or processor cores) 710, one or more memory/storage devices 720, and one or more communication resources 730, each of which may be communicatively coupled via a bus 740. For embodiments where node virtualization (e.g., NFV) is utilized, a hypervisor 702 may be executed to provide an execution environment for one or more network slices/sub-slices to utilize the hardware resources 700.

The processors 710 may include, for example, a processor 712 and a processor 714 which may be, e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof.

The memory/storage devices 720 may include main memory, disk storage, or any suitable combination thereof. The memory/storage devices 720 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 730 may include interconnection or network interface components or other suitable devices to communicate with one or more peripheral devices 704 or one or more databases 706 via a network 708. For example, the communication resources 730 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 750 may comprise software, a program, an application, an applet, an app, or other executable code for causing at least any of the processors 710 to perform any one or more of the methodologies discussed herein. The instructions 750 may reside, completely or partially, within at least one of the processors 710 (e.g., within the processor's cache memory), the memory/storage devices 720, or any suitable combination thereof. Furthermore, any portion of the instructions 750 may be transferred to the hardware resources 700 from any combination of the peripheral devices 704 or the databases 706. Accordingly, the memory of processors 710, the memory/storage devices 720, the peripheral devices 704, and the databases 706 are examples of computer-readable and machine-readable media.

FIG. 8 is a block diagram of an example processor platform in accordance with some embodiments of the disclosure. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In some embodiments, the processor implements one or more of the methods or processes described above.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes interface circuitry 820. The interface circuitry 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuitry 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, and/or a voice recognition system.

One or more output devices 824 are also connected to the interface circuitry 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuitry 820 of the illustrated example, thus, typically includes a graphics driver card, a graphics driver chip and/or a graphics driver processor.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

For example, the interface circuitry 820 may include a training dataset inputted through the input device(s) 822 or retrieved from the network 826.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

Machine executable instructions 832 may be stored in the mass storage device 828, in the volatile memory 814, in the non-volatile memory 816, and/or on a removable non-transitory computer readable storage medium such as a CD or DVD.

The following paragraphs describe examples of various embodiments.

Example 1 includes an apparatus, comprising: interface circuitry configured to receive a training dataset; and processor circuitry coupled to the interface circuitry, the processor circuitry being configured to: generate a small ground truth dataset by selecting images with a ground truth number of 1 from the training dataset; generate a calibration dataset randomly from the training dataset; if any image in the calibration dataset has the ground truth number of 1, remove the image from the small ground truth dataset; generate a label balanced calibration dataset by replacing an image with a ground truth number greater than a preset threshold in the calibration dataset with a replacing image selected randomly from the small ground truth dataset; and perform calibration using the label balanced calibration dataset in post-training quantization of a deep neural network (DNN).

Example 2 includes the apparatus of Example 1, wherein the processor circuitry is configured to generate the label balanced calibration dataset by, for each image in the calibration dataset, appending the image to the label balanced calibration dataset, under a condition that a ground truth number of the image is not greater than the preset threshold; or under a condition that the ground truth number of the image is greater than the preset threshold, selecting randomly the replacing image for the image from the small ground truth dataset, appending the replacing image to the label balanced calibration dataset, and removing the replacing image from the small ground truth dataset.

Example 3 includes the apparatus of Example 1 or 2, wherein the preset threshold is 5.

Example 4 includes the apparatus of Example 1, wherein the DNN comprises a multi-label DNN for object detection or instance segmentation.

Example 5 includes the apparatus of Example 1, wherein the training dataset comprises a Common Objects in Context (COCO) dataset.

Example 6 includes the apparatus of Example 1, wherein the post-training quantization reduces precision of parameters of the DNN from float 32 bits to integer 8 bits.

Example 7 includes a method, comprising: generating a small ground truth dataset by selecting images with a ground truth number of 1 from a training dataset; generating a calibration dataset randomly from the training dataset; if any image in the calibration dataset has the ground truth number of 1, removing the image from the small ground truth dataset; generating a label balanced calibration dataset by replacing an image with a ground truth number greater than a preset threshold in the calibration dataset with a replacing image selected randomly from the small ground truth dataset; and performing calibration using the label balanced calibration dataset in post-training quantization of a deep neural network (DNN).

Example 8 includes the method of Example 7, wherein generating the label balanced calibration dataset comprises: for each image in the calibration dataset, appending the image to the label balanced calibration dataset, under a condition that a ground truth number of the image is not greater than the preset threshold; or under a condition that the ground truth number of the image is greater than the preset threshold, selecting randomly the replacing image for the image from the small ground truth dataset, appending the replacing image to the label balanced calibration dataset, and removing the replacing image from the small ground truth dataset.

Example 9 includes the method of Example 7 or 8, wherein the preset threshold is 5.

Example 10 includes the method of Example 7, wherein the DNN comprises a multi-label DNN for object detection or instance segmentation.

Example 11 includes the method of Example 7, wherein the training dataset comprises a Common Objects in Context (COCO) dataset.

Example 12 includes the method of Example 7, wherein the post-training quantization reduces precision of parameters of the DNN from float 32 bits to integer 8 bits.

Example 13 includes a machine readable storage medium having instructions stored thereon, which when executed by a machine, cause the machine to perform operations, comprising: generating a small ground truth dataset by selecting images with a ground truth number of 1 from a training dataset; generating a calibration dataset randomly from the training dataset; if any image in the calibration dataset has the ground truth number of 1, removing the image from the small ground truth dataset; generating a label balanced calibration dataset by replacing an image with a ground truth number greater than a preset threshold in the calibration dataset with a replacing image selected randomly from the small ground truth dataset; and performing calibration using the label balanced calibration dataset in post-training quantization of a deep neural network (DNN).

Example 14 includes the machine readable storage medium of Example 13, wherein generating the label balanced calibration dataset comprises: for each image in the calibration dataset, appending the image to the label balanced calibration dataset, under a condition that a ground truth number of the image is not greater than the preset threshold; or under a condition that the ground truth number of the image is greater than the preset threshold, selecting randomly the replacing image for the image from the small ground truth dataset, appending the replacing image to the label balanced calibration dataset, and removing the replacing image from the small ground truth dataset.

Example 15 includes the machine readable storage medium of Example 13 or 14, wherein the preset threshold is 5.

Example 16 includes the machine readable storage medium of Example 13, wherein the DNN comprises a multi-label DNN for object detection or instance segmentation.

Example 17 includes the machine readable storage medium of Example 13, wherein the training dataset comprises a Common Objects in Context (COCO) dataset.

Example 18 includes the machine readable storage medium of Example 13, wherein the post-training quantization reduces precision of parameters of the DNN from float 32 bits to integer 8 bits.

Example 19 includes a device, comprising: means for generating a small ground truth dataset by selecting images with a ground truth number of 1 from a training dataset; means for generating a calibration dataset randomly from the training dataset; means for, if any image in the calibration dataset has the ground truth number of 1, removing the image from the small ground truth dataset; means for generating a label balanced calibration dataset by replacing an image with a ground truth number greater than a preset threshold in the calibration dataset with a replacing image selected randomly from the small ground truth dataset; and means for performing calibration using the label balanced calibration dataset in post-training quantization of a deep neural network (DNN).

Example 20 includes the device of Example 19, wherein the means for generating the label balanced calibration dataset comprises means for performing operations for each image in the calibration dataset, the operations comprising: appending the image to the label balanced calibration dataset, under a condition that a ground truth number of the image is not greater than the preset threshold; or under a condition that the ground truth number of the image is greater than the preset threshold, selecting randomly the replacing image for the image from the small ground truth dataset, appending the replacing image to the label balanced calibration dataset, and removing the replacing image from the small ground truth dataset.

Example 21 includes the device of Example 19 or 20, wherein the preset threshold is 5.

Example 22 includes the device of Example 19, wherein the DNN comprises a multi-label DNN for object detection or instance segmentation.

Example 23 includes the device of Example 19, wherein the training dataset comprises a Common Objects in Context (COCO) dataset.

Example 24 includes the device of Example 19, wherein the post-training quantization reduces precision of parameters of the DNN from float 32 bits to integer 8 bits.

Example 25 includes a computer program product, having programs to perform the method of any of Examples 7 to 12.

Example 26 includes an apparatus as shown and described in the description.

Example 27 includes a method performed at an apparatus as shown and described in the description.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. The disclosure is intended to cover any adaptations or variations of the embodiments discussed herein. Therefore, it is manifestly intended that embodiments described herein be limited only by the appended claims and the equivalents thereof.

1-24. (canceled)

25. An apparatus, comprising:
interface circuitry configured to receive a training dataset; and
processor circuitry coupled to the interface circuitry, the processor circuitry being configured to:
generate a small ground truth dataset by selecting images with a ground truth number of 1 from the training dataset;
generate a calibration dataset randomly from the training dataset;
if any image in the calibration dataset has the ground truth number of 1, remove the image from the small ground truth dataset;
generate a label balanced calibration dataset by replacing an image with a ground truth number greater than a preset threshold in the calibration dataset with a replacing image selected randomly from the small ground truth dataset; and
perform calibration using the label balanced calibration dataset in post-training quantization of a deep neural network (DNN).

26. The apparatus of claim 25, wherein the processor circuitry is configured to generate the label balanced calibration dataset by,
for each image in the calibration dataset,
appending the image to the label balanced calibration dataset, under a condition that a ground truth number of the image is not greater than the preset threshold; or
under a condition that the ground truth number of the image is greater than the preset threshold,
selecting randomly the replacing image for the image from the small ground truth dataset,
appending the replacing image to the label balanced calibration dataset, and
removing the replacing image from the small ground truth dataset.

27. The apparatus of claim 25, wherein the preset threshold is 5.

28. The apparatus of claim 25, wherein the DNN comprises a multi-label DNN for object detection or instance segmentation.

29. The apparatus of claim 25, wherein the training dataset comprises a Common Objects in Context (COCO) dataset.

30. The apparatus of claim 25, wherein the post-training quantization reduces precision of parameters of the DNN from float 32 bits to integer 8 bits.

31. A method, comprising:
generating a small ground truth dataset by selecting images with a ground truth number of 1 from a training dataset;
generating a calibration dataset randomly from the training dataset;
if any image in the calibration dataset has the ground truth number of 1, removing the image from the small ground truth dataset;
generating a label balanced calibration dataset by replacing an image with a ground truth number greater than a preset threshold in the calibration dataset with a replacing image selected randomly from the small ground truth dataset; and
performing calibration using the label balanced calibration dataset in post-training quantization of a deep neural network (DNN).

32. The method of claim 31, wherein generating the label balanced calibration dataset comprises:
for each image in the calibration dataset,
appending the image to the label balanced calibration dataset, under a condition that a ground truth number of the image is not greater than the preset threshold; or
under a condition that the ground truth number of the image is greater than the preset threshold,
selecting randomly the replacing image for the image from the small ground truth dataset,
appending the replacing image to the label balanced calibration dataset, and
removing the replacing image from the small ground truth dataset.

33. The method of claim 31, wherein the preset threshold is 5.

34. The method of claim 31, wherein the DNN comprises a multi-label DNN for object detection or instance segmentation.

35. The method of claim 31, wherein the training dataset comprises a Common Objects in Context (COCO) dataset.

36. The method of claim 31, wherein the post-training quantization reduces precision of parameters of the DNN from float 32 bits to integer 8 bits.

37. A non-transitory machine readable storage medium having instructions stored thereon, which when executed by a machine, cause the machine to perform operations, comprising:
generating a small ground truth dataset by selecting images with a ground truth number of 1 from a training dataset;
generating a calibration dataset randomly from the training dataset;
if any image in the calibration dataset has the ground truth number of 1, removing the image from the small ground truth dataset;
generating a label balanced calibration dataset by replacing an image with a ground truth number greater than a preset threshold in the calibration dataset with a replacing image selected randomly from the small ground truth dataset; and
performing calibration using the label balanced calibration dataset in post-training quantization of a deep neural network (DNN).

38. The non-transitory machine readable storage medium of claim 37, wherein generating the label balanced calibration dataset comprises:
for each image in the calibration dataset,
appending the image to the label balanced calibration dataset, under a condition that a ground truth number of the image is not greater than the preset threshold; or
under a condition that the ground truth number of the image is greater than the preset threshold,
selecting randomly the replacing image for the image from the small ground truth dataset,
appending the replacing image to the label balanced calibration dataset, and
removing the replacing image from the small ground truth dataset.

39. The non-transitory machine readable storage medium of claim 37, wherein the preset threshold is 5.

40. The non-transitory machine readable storage medium of claim 37, wherein the DNN comprises a multi-label DNN for object detection or instance segmentation.

41. The non-transitory machine readable storage medium of claim 37, wherein the training dataset comprises a Common Objects in Context (COCO) dataset.

42. The non-transitory machine readable storage medium of claim 37, wherein the post-training quantization reduces precision of parameters of the DNN from float 32 bits to integer 8 bits.
